(19) United States
(12) Patent Application Publication
(10) Pub. No.: US 2012/0221248 A1
(43) Pub. Date: Aug. 30, 2012

(54) METHODS AND COMPUTING SYSTEMS FOR IMPROVED IMAGING OF ACQUIRED DATA

(76) Inventors: CAN EVREN YARMAN, HOUSTON, TX (US); ROBIN FLETCHER, GUILDFORD (GB)

(21) Appl. No.: 13/332,096

(22) Filed: Dec. 20, 2011

Related U.S. Application Data
(60) Provisional application No. 61/425,635, filed on Dec. 21, 2010.
(60) Provisional application No. 61/439,149, filed on Feb. 3, 2011.

(51) Int. Cl. G06F 19/00; G01V 1/34; G01N 21/00; G01J 1/00

(52) U.S. Cl. 702/16; 356/213; 356/72

(57) ABSTRACT

Methods and computing systems are disclosed to enhance imaging of acquired data. In one embodiment, a method is performed that includes receiving acquired data that corresponds to the medium; computing a first wavefield by injecting a noise; and computing the cumulative illumination by auto-correlating the first wavefield.

### CROSS-REFERENCE TO RELATED APPLICATIONS

The present application claims benefit under 35 U.S.C. §119(e) of U.S. Provisional Application Ser. No. 61/425,635 filed Dec. 21, 2010, titled, “Limited Finite Aperture Acquisition Compensation for Shot Profile Imaging” (Attorney Docket No. IS10.0876-(DP)-US-PSP); and of U.S. Provisional Application Ser. No. 61/439,149 filed Feb. 3, 2011, titled, “Uses of Random Noise in Imaging and Modeling” (Attorney Docket No. IS 10.0572-US-PSP(DP)); both of which are incorporated herein by reference in their entirety.

### TECHNICAL FIELD

This disclosure relates generally to data processing, and more particularly, to computing systems and methods for imaging acquired data.

### BACKGROUND

Data acquisition, gathering, and processing for imaging is used in many physical sciences and engineering fields, such as in geophysical exploration, bio-medical diagnosis and treatment, non-destructive engineering structure investigation, environmental or military surveillance etc. For seismic exploration, which is one of the most frequently used exploration methods for hydrocarbon deposits and other valuable minerals, imaging or seismic images produced from seismic data are important tools. Computation of source and receiver illuminations is important in producing images with balanced amplitudes. Once the amplitude within the image is balanced, interesting objects or structures within the image can be more easily identified or interpreted as such.

Using seismic imaging application as an example, for a given shot gather, corresponding source-impulse-response is obtained by propagating the source wavefield. Then the source illumination is computed by the zero-time autocorrelation of the source-impulse-response. This approach can be used to compute the cumulative receiver illumination by summing up zero-time autocorrelation of the individual receiver impulses. However, this procedure is computationally very expensive and time consuming.

There have been several attempts to compensate or balance the amplitudes in seismic images produced by Reversed Time Migration (RTM). In Chattopadhyay and McMechan (2008), it was shown that cross-correlation based imaging condition with source impulse compensation produces amplitudes that better represent the reflectivity of the model. In Costa et al. (2009), an obliquity correcting factor based on the asymptotic analysis of Haney et al. (2005) was introduced in the source-normalized cross-correlation imaging condition. This obliquity is computed based on the reflector dip.

Another method for obliquity factor was introduced by Zhang and Sun (2008), where the obliquity factor is computed based on the opening angle of the incident and reflector rays and applied on the angle gathers.

Finite aperture compensation was considered in Plessix et al. (2004). Due to high computational demand, crude approximations were performed in order to compute the receiver weights.

All the above methods are either computationally very expensive and time consuming, or over simplified and insufficient to represent receiver side illumination within a complex geology.

Accordingly, there is a need for methods and computing systems that can employ faster, more efficient, and more accurate methods for imaging acquired data. Such methods and computing systems may complement or replace conventional methods and computing systems for imaging acquired data.

### SUMMARY

The above deficiencies and other problems associated with imaging acquired data are reduced or eliminated by the disclosed methods and computing systems.

In accordance with some embodiments, a method for obtaining a cumulative illumination of a medium for imaging or modeling is performed that includes: receiving acquired data that corresponds to the medium; computing a first wavefield by injecting a noise; and computing the cumulative illumination by auto-correlating the first wavefield.

In accordance with some embodiments, a computing system is provided that includes at least one processor, at least one memory, and one or more programs stored in the at least one memory, wherein the one or more programs are configured to be executed by the one or more processors, the one or more programs including instructions for receiving acquired data that corresponds to the medium; computing a first wavefield by injecting a noise; and computing a cumulative illumination by auto-correlating the first wavefield.

In accordance with some embodiments, a computer readable storage medium is provided, the medium having a set of one or more programs including instructions that when executed by a computing system cause the computing system to: receive acquired data that corresponds to the medium; compute a first wavefield by injecting a noise; and compute a cumulative illumination by auto-correlating the first wavefield.

In accordance with some embodiments, a computing system is provided that includes at least one processor, at least one memory, and one or more programs stored in the at least one memory; and means for receiving acquired data that corresponds to the medium; means for computing a first wavefield by injecting a noise; and means for computing a cumulative illumination by auto-correlating the first wavefield.

In accordance with some embodiments, an information processing apparatus for use in a computing system is provided, and includes means for receiving acquired data that corresponds to the medium; means for computing a first wavefield by injecting a noise; and means for computing a cumulative illumination by auto-correlating the first wavefield.

In some embodiments, an aspect of the invention includes that the noise is injected at one or more receiver locations.

In some embodiments, an aspect of the invention includes that the noise is injected into a region of interest in the medium.

In some embodiments, an aspect of the invention involves computing a source wavefield by injecting a source waveform into the medium; and computing a source illumination by autocorrelation of the source wavefield.

In some embodiments, an aspect of the invention involves cross-correlating the source wavefield and the first wavefield to obtain a first image; and computing an illumination balanced image by dividing the image with the source illumination and the cumulative illumination.

In some embodiments, an aspect of the invention includes that the noise is white noise having zero mean and unit variance.

In some embodiments, an aspect of the invention includes that the noise is based at least in part on an image statistic selected from the group consisting of ergodicity, level of correlation and stationarity.

In some embodiments, an aspect of the invention includes that the noise is a directional noise along a direction of interest, and that the illumination balanced image is illuminated along the direction of interest.

In some embodiments, an aspect of the invention involves varying the direction of the directional noise to generate a directionally illuminated image; and correlating the directionally illuminated image for amplitude variation along angles analysis.

In some embodiments, an aspect of the invention involves recording the first wavefield at a source location and at a receiver location, wherein the first wavefield is based at least in part on the injected noise; generating a synthetic trace by convolving the recorded wavefield at the source location with the recorded wavefield at the receiver location; and obtaining one or more weights by computing coherence of the synthetic trace with a trace in the acquired data, wherein the synthetic trace corresponds to the trace in the acquired data, (e.g., both the synthetic trace and the trace in the acquired data share a source location and a receiver location).

In some embodiments, an aspect of the invention includes that the first image is for seismic imaging, and the weights are calculated for Reverse Time Migration (RTM) or Full Waveform Inversion (FWI).

In some embodiments, an aspect of the invention involves computing a receiver wavefield by backward propagation of one or more shots into the medium; generating a random noise; replacing at least part of the acquired data with the random noise; computing an adjusted wavefield by backward propagating the random noise through at least part of the medium; and computing a receiver illumination by auto-correlating the adjusted wavefield.

In some embodiments, an aspect of the invention involves generating a second image based at least in part on the adjusted wavefield.

In some embodiments, an aspect of the invention includes that the second image is generated by summing a plurality of processed shots into the second image on a shot-by-shot basis.

In some embodiments, an aspect of the invention includes that the second image is generated by summing a plurality of shots after individual shot processing.

In some embodiments, an aspect of the invention involves processing the second image to compensate for a finite aperture.

In some embodiments, an aspect of the invention includes generating a third noise; backward propagation of the generated third noise into the medium; auto-correlation of the adjusted wavefield to obtain a compensating imaging condition; and processing the second image with the compensating imaging condition.

In some embodiments, an aspect of the invention includes that the image is for seismic imaging, radar imaging, sonar imaging, thermo-acoustic imaging or ultra-sound imaging.

Thus, the computing systems and methods disclosed herein are faster, more efficient methods for imaging acquired data. These computing systems and methods increase imaging effectiveness, efficiency, and accuracy. Such methods and computing systems may complement or replace conventional methods for imaging acquired data.

### BRIEF DESCRIPTION OF THE DRAWINGS

A better understanding of the methods can be had when the following detailed description of the several embodiments is considered in conjunction with the following drawings, in which:

FIG. 1 shows a flow diagram of one method of noise injection in accordance with some embodiments.

FIG. 2 shows the Sigsbee model for testing a method in accordance with some embodiments.

FIGS. 3a and 3b show example source illuminations and cumulative receiver illuminations, respectively, for the model as in FIG. 2.

FIG. 4 shows an example image obtained by a correlation image condition in accordance with some embodiments.

FIG. 5 shows an example source illumination compensated image of FIG. 4.

FIG. 6 shows an example image with both source and receiver illuminations compensated for the image of FIG. 4.

FIG. 7 shows a model for computing shot profile migration in accordance with some embodiments.

FIG. 8 shows a model for computing shot profile migration in accordance with some embodiments.

FIGS. 9A and 9B illustrate flow diagrams of image compensation methods using noise injection in accordance with some embodiments.

FIG. 10 shows an example conventional RTM image of Sigsbee model.

FIG. 11 shows an example RTM image of Sigsbee model with limited-receiver-aperture compensation.

FIG. 12 shows the normal incidence reflectivity of Sigsbee model in accordance with some embodiments.

FIG. 13 illustrates a computing system in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first object or step could be termed a second object or step, and, similarly, a second objector step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In this application, various random noise injection methods for imaging and modeling are disclosed. One of them is a method to efficiently compute an approximation to a cumulative receiver illumination using random noise injection. In some embodiments, the estimate of the cumulative receiver illumination by injecting random noise from all relevant receivers is done all at once.

Using random noise injection methods, one can also perform receiver illumination and source illumination compensation, which can be utilized for full waveform inversion (FWI) and tomography, model validation, targeted imaging, illumination analysis, amplitude versus offset/angle analysis, amplitude balancing. Receiver illumination and source illumination compensation can also be utilized for conducting shot profile migration and imaging, computing true amplitude weights, suppressing imaging artifacts/noises, and many others.

Consider an acoustic wave equation, related imaging condition and use the following data model:

$$d ( r , s , ω ) = {\int }_{r ∈ Γ ( s )} {G}_{u} ( r , x , ω ) {G}_{u} ( s , x , ω ) p ( ω ) T ( x ) d x , \qquad ( 1 )$$

where p(w) denotes the source wavelet, s and r denote source and receiver locations, respectively, Γ(s) is the set of receivers used during given shot gather indexed by s, Gᵤ(y, x, ω) is the unknown Green's function of the medium from y to x, and T(x) is the unknown image of the medium that we aim to reconstruct from the data, d(r,s,ω), which is the recorded wavefield data in frequency domain. We approximate the unknown Greens function with G₀(y, x, ω) and write an approximation to the data as

$$d ( r , s , ω ) \approx {\int }_{r ∈ Γ ( s )} {G}_{0} ( r , x , ω ) {G}_{0} ( s , x , ω ) p ( ω ) T ( x ) d x . \qquad ( 2 )$$

G₀(s, x, ω) and G₀(r, x, ω) are also referred to as the source and receiver impulse responses, respectively.

Let us define source and receiver wavefields by

$$\begin{matrix}S ( s , x , ω ) = {G}_{0} ( s , x , ω ) p ( ω ) , \\ and & ( 3 ) \\ R ( s , x , ω ) = {\int }_{r ∈ Γ ( s )} {G}_{0} ( r , x , ω ) {d}^{*} ( r , s , ω ) d r , & ( 4 )\end{matrix}$$

where * denotes complex conjugation. Then, for a given shot gather, the standard correlation imaging condition is given by

$$\begin{matrix}{I}_{C} ( z , s ) = \int S ( s , z , ω ) R ( s , z , ω ) d ω \\ = \int {G}_{0} ( s , z , ω ) p ( ω ) {G}_{0} ( r , z , ω ) {d}^{*} ( s , r , ω ) d r d ω \\ \approx \int {G}_{0} ( s , z , ω ) {G}_{0}^{*} ( s , x , ω ) {\vert p ( ω ) \vert}^{2} \\ [ {\int }_{Γ ( s )} {G}_{0} ( r , z , ω ) {G}_{0}^{*} ( r , x , ω ) d r ] T ( x ) d x d ω\end{matrix} \qquad ( 5 )$$

Assuming that the majority of the contribution to the x-integral is due to x=z, we can approximate I_{C}(z,s) by

$$\begin{matrix}{I}_{C} ( z , s ) \approx T ( z ) \int {\vert {G}_{0} ( s , z , ω ) \vert}^{2} {\vert p ( ω ) \vert}^{2} [ {\int }_{Γ ( s )} {\vert {G}_{0} ( r , z , ω ) \vert}^{2} d r ] d ω \\ \approx T ( z ) \int {\vert S ( s , z , ω ) \vert}^{2} [ {\int }_{Γ ( s )} {\vert {G}_{0} ( r , z , ω ) \vert}^{2} d r ] d ω .\end{matrix} \qquad ( 6 )$$

Using the integral inequality ∫fg≦∫f∫g, for f, g≧0, we modify (6) as

I_{C}(z,s)≦T(z)[∫|S(s,z,ω)|²dω][∫[∫_{Γ(s)}|G₀(r,z,ω)|²dr]dω]. (7)

and obtain a lower bound for T(z) by

$$T ( z ) \geq \frac{{I}_{C} ( z , s )}{[ \int {\vert S ( s , z , ω ) \vert}^{2} d ω ] [ \int [ {\int }_{Γ ( s )} {\vert {G}_{0} ( r , z , ω ) \vert}^{2} d r ] d ω ]} . \qquad ( 8 )$$

The first term in the denominator, [∫|S(s,z,ω)|²dω], the zero-time autocorrelation of source wavefield, which is referred to as a source illumination, and the second term is the sum of receiver illuminations, which we define by zero-time autocorrelation of receiver impulse responses. We refer to the sum of receiver illuminations as the cumulative receiver illumination.

In some embodiments, a cumulative receiver illumination can be approximated by injecting random noise into the medium. In this regard, let n(s, r, t) be the zero mean, unit variance white noise which is uncorrelated in source and receiver coordinates and in time, E[.] denotes the expectation operator:

E[n(s,r,t)]=0, E[n(s,r,t)n(s′,r′,t′)]=δ(s−s′)δ(r−r′)δ(t−t′), (9)

where δ denotes the Dirac delta function. Then

$$\begin{matrix}\begin{matrix} E [ \tilde{n} ( s , r , ω ) {\tilde{n}}^{*} ( {s}^{′} , {r}^{′} , ω ) ] = \int δ ( s - {s}^{′} ) δ ( r - {r}^{′} ) δ ( t - {t}^{′} ) {e}^{iω ( t - {t}^{′} )} \\ = δ ( s - {s}^{′} ) δ ( r - {r}^{′} ) [ {t}_{max} - {t}_{min} ] ,\end{matrix} \\ where t , {t}^{′} ∈ [ {t}_{min} , {t}_{max} ] , and & ( 10 ) \\ \tilde{n} ( s , r , ω ) = \int n ( s , r , t ) {e}^{iω t} d t . \\ Then & ( 11 ) \\ E [ \int {\vert {\int }_{Γ ( s )} {G}_{0} ( r , z , ω ) \tilde{n} ( s , r , ω ) d r \vert}^{2} d ω ] = \int [ {\int }_{Γ ( s )} {\int }_{Γ ( s )} {G}_{0} ( r , z , ω ) {G}_{0}^{*} ( {r}^{′} , z , ω ) E [ \tilde{n} ( s , r , ω ) {\tilde{n}}^{*} ( s , {r}^{′} , ω ) ] d r d {r}^{′} ] d ω = [ {t}_{max} - {t}_{min} ] \int [ {\int }_{Γ ( s )} {\vert {G}_{0} ( r , z , ω ) \vert}^{2} d r ] d ω & ( 12 )\end{matrix}$$

The right-hand-side (RHS) of Eq. (12) is the term in Eq. (8) that we try to get. Eq. (12) indicates that one can approximate the cumulative receiver illumination (the RHS) by injecting random noise from the receiver locations and then by computing an autocorrelation of the resulting wavefield (the left-hand-side (LHS) of Eq. (12)). In some embodiments, this is autocorrelation is performed at time zero.

One can utilize this method for many tasks, including without limitation: computing true amplitude imaging, finite/limited receiver aperture compensated imaging, illumination amplitude analysis, seismic acquisition design and full waveform inversion. With a few additional steps or variations, the methods can be used for computing weights as semblance for shot profile migration, or a generalized semblance. The semblance can be tailored for a particular region of interest to perform targeted imaging. The targeted area can be used back in data domain to focus the data. The resulting weights are true amplitude weights, which can provide a measure of targeted imaging/illumination, or point-wise illumination. The normalized weights between 0 and 1 can be used as a focusing criterion for tomography. The weights can be used for further illumination studies and consequently for acquisition design. The weights may also be used in wave based picking of features of potential interest, such as target horizons, dips, multiples, or other subsurface features, because the weights are cumulative Green's function responses of the medium.

The injected noises can be varied not only in spatial extent, but also in directional extent. With directional noises, the methods can be used for targeted illumination analysis, directional illumination analysis and compensation, or amplitude versus offset/angle analysis (AVA). In seismic imaging for oil exploration, the AVA is very useful for reservoir characterization.

Although the discussion and examples are for seismic imaging, the methods for seismic imaging are applicable to other imaging modalities, so long as there are sources, receivers and unknown structures to be imaged. In some embodiments where the techniques and methods disclosed here may be used successfully, one or more sources emit energy that propagates through a medium and is received by one or more receivers. For example, in the case of seismic surveying, a seismic source may be activated, causing a seismic wave to propagate through the earth, and is then received by a seismic receiver. Other imaging modalities may include radar imaging, other electromagnetic based imaging modalities, sonar, thermo-acoustic imaging, ultrasound or other medical imaging modalities, etc.

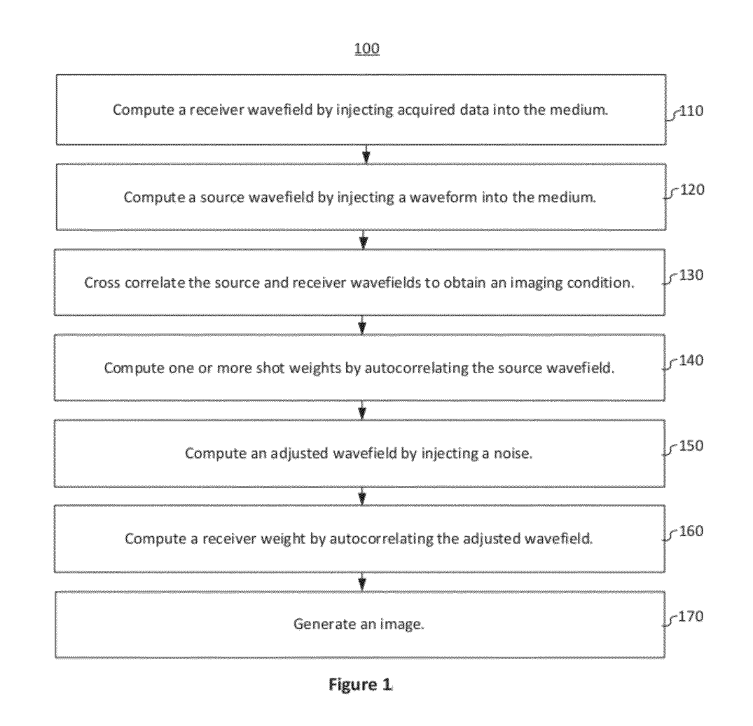

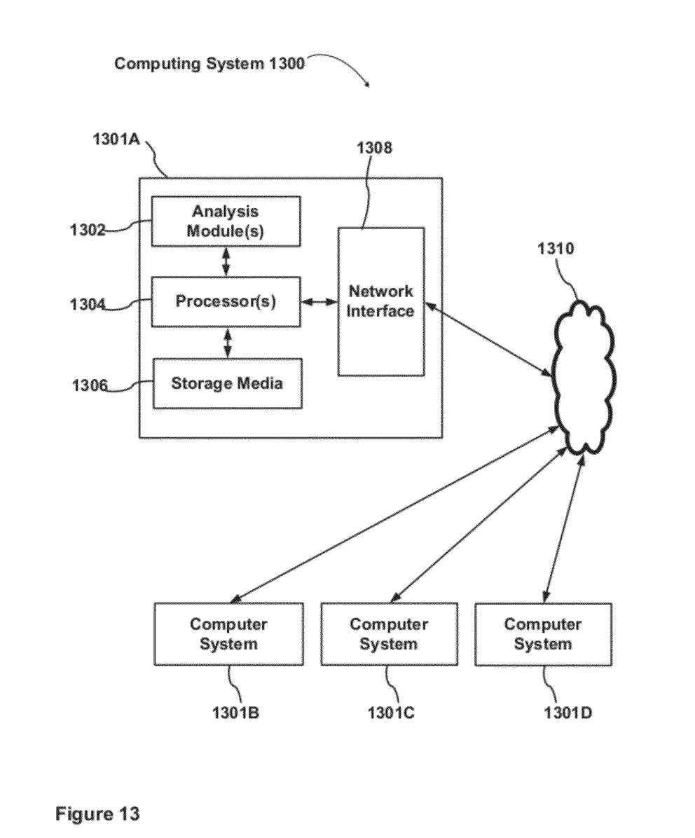

Attention is now directed to FIG. 1, which is a flow diagram illustrating a method 100 in accordance with some embodiments. Some operations in method 100 may be combined and/or the order of some operations may be changed. Additionally, operations in method 100 may be combined with aspects of methods 900 and/or 950 discussed below, and/or the order of some operations in method 100 may be changed to account for incorporation of aspects of methods 900 and/or 950. Method 100 may be performed by any suitable technique(s), including on an automated or semi-automated basis on computing system 1300 in FIG. 13.

At step 110, compute a receiver wavefield (e.g., R(z,s,t)) by injecting acquired data into the medium.

At step 120, compute a source wavefield (e.g., S(z,s,t)) by injecting a waveform (e.g., AO) into the medium.

At step 130, cross correlate the source and receiver wavefields to obtain an image (e.g., Ic(z,s)).

At step 140, compute a shot weight by autocorrelation of the source wavefield. In some embodiments, the autocorrelation is at time zero.

At step 150, compute an adjusted wavefield (e.g., Rₙ(r,z,t)) by injecting a noise (e.g., any suitable noise may be used, including without limitation, the example of a zero mean Gaussian white noise with unit variance, i.e., Rₙ(r,z,t)=G₀(r,z, t)*n(r,t)).

At step 160, compute a receiver weight by autocorrelating the adjusted wavefield (e.g., autocorrelate Rₙ at time zero to derive the receiver weight).

At step 170, generate an image. In some embodiments, the image is generated in accordance with the example of Eq. (8) by dividing the image by both the autocorrelation of the source wavefield and the adjusted wavefield.

The above discussion is focused on obtaining an image (which may be referred to as T(z) herein). When an image is not the immediate goal, but one needs to compute data or image semblance weights, then not all the steps are necessary. For example, in some imaging projects where the receiver illumination is problematic or uneven, the noise injection is applied to the receiver wavefield for quality control. In this case, only steps related to receiver illumination are needed, i.e., steps 150 and 160.

It is important to recognize that interpretations of collected data and imaging of that data may be refined in an iterative fashion; this concept is applicable to the methods discussed herein, including method 100. Finally, method 100 may be performed by any suitable techniques, including on an automated or semi-automated basis on computing system 1300 in FIG. 13.

As mentioned above, similar white noise injection methods may be used for many other purposes. For example, since RTM is based on techniques similar to gradient computation in full waveform inversion (FWI), the noise injection method can be utilized in FWI as a preconditioner, which should improve the convergence of FWI. More on shot profile migration is discussed below.

Whilst the method above is derived using two-way wavefield extrapolation migration (e.g., for RTM), where both the source wavefield and the receiver wavefield are propagated, it is equally applicable to any shot-profile migration, one-way wavefield extrapolation migration, Gaussian beam, Kirchhoff, etc.

The method can also be applied to the limited/finite receiver illumination for plane wave or any other simultaneous source migration/inversions with minor modifications. Limited aperture compensation is discussed in more detail below.

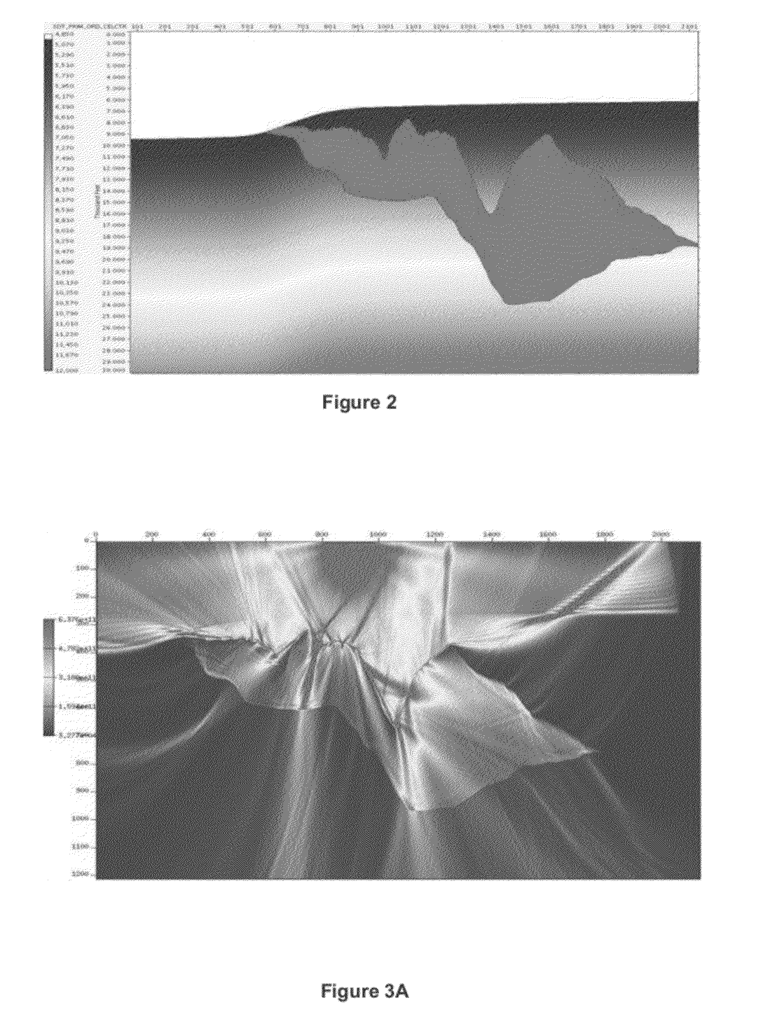

Whilst in the examples shown as in FIGS. 2-6, we used independent identically distributed Gaussian noise, one may use prior knowledge or build up statistics under appropriate assumptions on ergodicity, correlatedness or uncorrelatedness, stationarity, etc., of the data to derive finite/limited receiver aperture weights. Using noises with other properties may derive many other benefits, as will be discussed below.

The cost is equal to the cost of shot profile migration (which may be referred to herein as SPM, and is discussed below) plus computation of the weights. In the example presented in FIGS. 2-6, the overhead for computing the weights was an extra 50% of the original migration. It is also possible to compute reasonable weights using a reduced frequency range, thereby reducing the overhead for computing the weights for a fast, automatic migration aperture calculation.

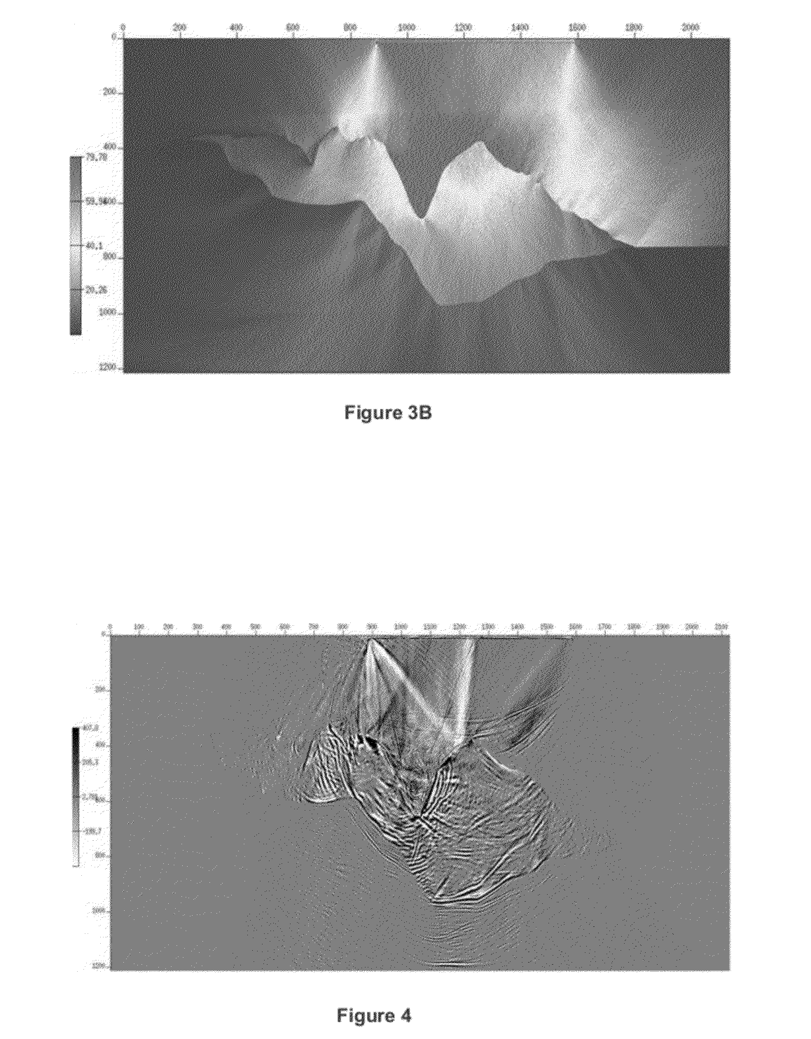

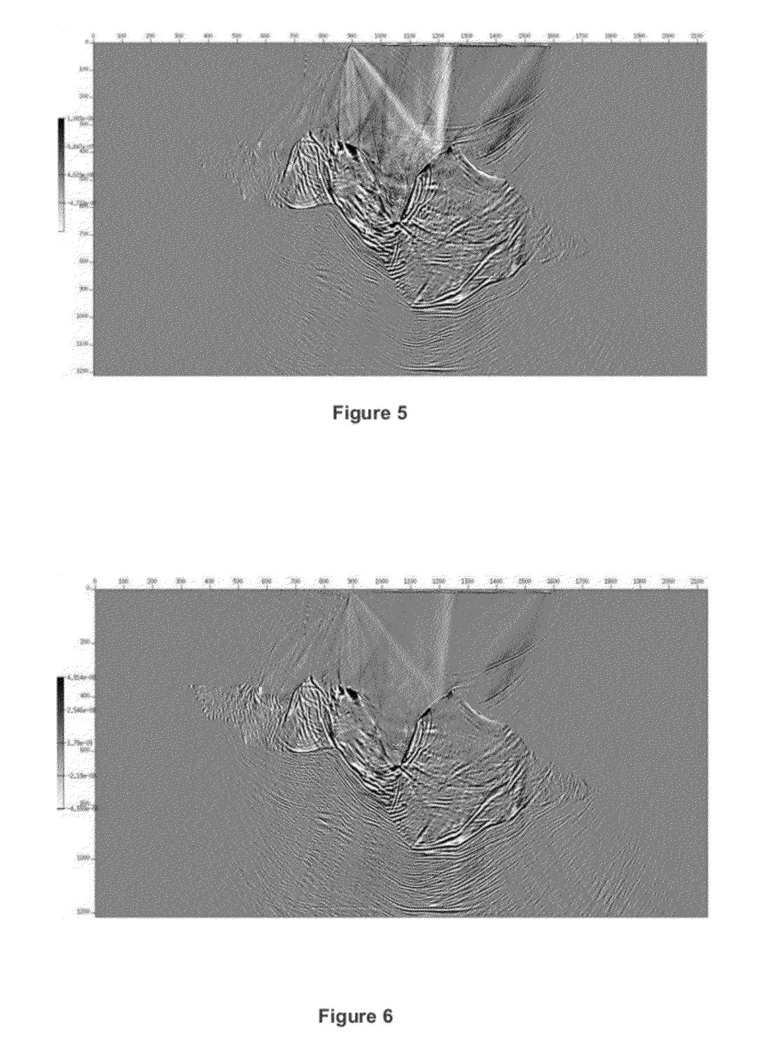

The methods were tested on the Sigsbee model. In FIG. 2, the well-known Sigsbee model is shown. In FIGS. 3a and 3b the source and approximate cumulative receiver illuminations are shown respectively, which are obtained from intermediate steps of the method 100 described above. In FIG. 4, the image obtained by correlation imaging condition of Eq. (6) is presented. This image is a typical image obtained without using the methods discussed above. The corresponding source illumination compensated image is shown in FIG. 5. The corresponding source and cumulative receiver illuminations compensated image according to Eq. (8) is shown in FIG. 6. The image in FIG. 5 is compensated for illumination on the source side only, while the image in FIG. 6 is compensated for both the source and the receiver sides. It can be clearly seen from FIG. 6 that the source and cumulative receiver illuminations compensated image boosts amplitudes below the salt and suppresses some of the acquisition related artifacts above the salt when compared to FIGS. 4 and 5. The examples of FIGS. 2-6 are described here as being obtained by performing method 100 using the specific example equations set forth in this disclosure. Those with skill in the art, however, will appreciate that variations of the equations disclosed herein, or alternative methods of calculating, deriving and/or generating the results of the equations disclosed herein, may also be used successfully with method 100 (or with methods 900 and 950 that are discussed below).

### Shot Profile Migration (SPM)

As mentioned above, noise injection into a wavefield can be used to perform Shot Profile Migration.

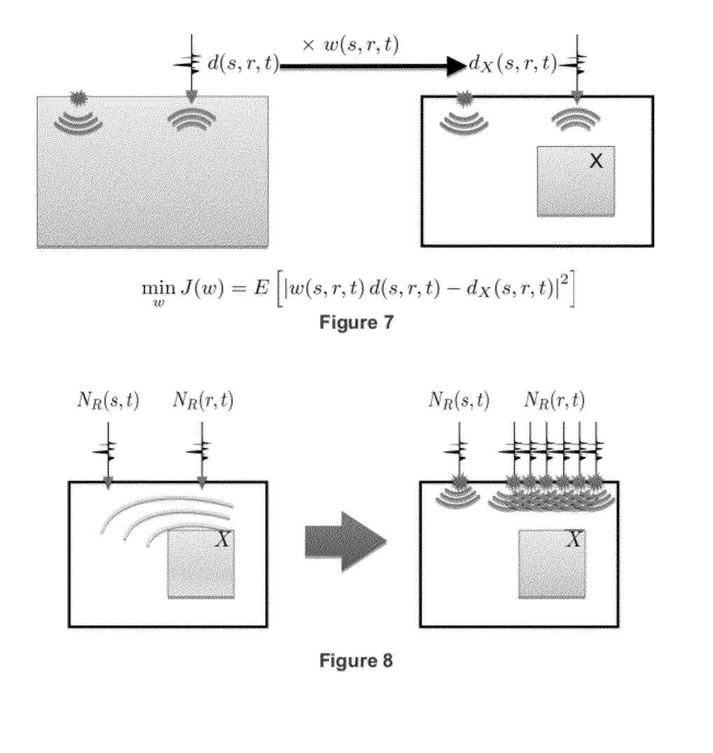

Sometimes, it is important to isolate the portion of the data that comes from a particular region of interest, especially, when we have limited acquisition aperture. Furthermore, for noise suppression it is important to find the portion of the data that is consistent with a pre-assumed underlying propagation model. In this regard, we use the noise injection method to compute weights, which we refer to as semblance for shot profile migration, so that when applied to the measurement data, the weighted data is as close as possible to the data that may come from a region of interest and consistent with the underlying propagation model. FIG. 7 illustrates the noise injection into a region of interest, typically a region away from receiver or source locations. In the case in Eq. (12), noises are injected at receiver locations. In many geophysical explorations, source and receiver locations are typically on the earth's surface, while regions of interest are beneath the earth's surface.

Since the semblance depends on the underlying propagation model, they are expected to reduce the noise in the measured data that is not consistent with the underlying propagation model. Thus if noise suppression is desired, the semblance can be used as a filter to suppress, at least partially, any noises that are inconsistent with the underlying model. Conversely, the semblance provides a measure of signal to signal plus noise ratio, thus can be used as a focusing criterion for model building and to validate the underlying model of propagation. When the model is perfect, then the normalized weights each have the value of one, but if the model is highly inaccurate, the normalized weights will be close to zero. If the average of the weights is very close to one, then the model is very close to a perfectly accurate representation of the medium. When the average of the weights is above a certain threshold, the model can be validated. The threshold may be predetermined and may be adjustable. If not, one may adjust the model structures or parameters to make the weights closer to the threshold.

One method to compute the semblance for SPM is to inject spatially and temporally uncorrelated Gaussian distributed random white noise from a region of interest X, as in FIG. 7. If more than one region is of interest, then noises are injected to those interested regions, which may or may not be contiguous. Then we record the injected noisy wavefield at all desired source and receiver locations as shown in the left panel in FIG. 8. Convolution of the recorded wavefields for each source-receiver pair gives the normalized cumulative response N_{X} of the region of interest as observed at the surface, as shown in the right panel in the FIG. 8.

Assuming a particular data model and the best approximation to the unknown medium of propagation, the coherence between N_{X} and the measured data defines the semblance for SPM. In some embodiments, a semblance computation for SPM can include:

Propagate random noise sources embedded in the region of interest X and record the wavefield at a plurality of possible source and receiver locations: N_{R}(y, t), y=s V r; (in some embodiments, one would record the wavefield at all possible source and receiver locations).

Convolve the recorded wavefield for a given source and receiver location:

N_{X}(s,r,t)=N_{R}(s,t)*N_{R}(r,t); (13)

Compute the weights by computing a local coherence of N_{X}(s,r,t) with data

$$w ( s , r , t ) = \frac{{\vert 〈 d ( s , t , t ) , E [ {N}_{X}^{*} ( s , r , t ) ] 〉 \vert}^{2}}{〈 d ( s , r , t ) , d ( s , r , t ) 〉 〈 E [ {N}_{X} ( s , r , t ) , E [ {N}_{X} ( s , r , t ) ] 〉} \qquad ( 14 )$$

Furthermore, rather than convolving the noise wavefields recorded at given source and receiver locations, if one injects them back into the medium and correlate to form a SPM image, the computed image provides an approximation to the true amplitude weights for SPM as illustrated below:

$$\begin{matrix}{N}_{R} ( y , t ) = {\int }_{X} {G}_{0} ( y , x , ω ) \tilde{n} ( x , ω ) {e}^{i 2 π ω t} d x d ω & ( 15 ) \\ \begin{matrix}{w}_{SPM} ( s , r , z ) = E [ \begin{matrix}\int [ {G}_{0} ( s , z , ω ) ( s , ω ) ] \\ [ {\sum }_{r} [ {G}_{0} ( r , z , ω ) ( r , ω ) ] ] d ω\end{matrix} ] \\ = \int {G}_{0} ( s , z , ω ) {G}_{0}^{*} ( r , x , ω ) \\ {\sum }_{r} [ {G}_{0 } ( r , z , ω ) {G}_{0}^{*} ( r , x , ω ) ] d x d ω\end{matrix} & ( 16 )\end{matrix}$$

Then the computed approximate true amplitude weights can be used to balance the amplitudes in the SPM images obtained from the measured data. The steps to compute the weights are summarized below:

Propagate random noise sources embedded in the region of interest X and record the wavefield at a plurality of source and receiver locations (and in some embodiments, at all possible source and receiver locations):

N_{R}(y,t),y=sVr (17)

Propagate and perform SPM on the recorded noisy source and receiver wavefields:

w_{SPM}(s,r,z)=∫[G₀(s,z,ω)\tilde{N_{R}*}(s,ω)](Σᵣ[G₀(r,z,ω)\tilde{N_{R}*}(r,ω)])dω (18)

Thus, a semblance for SPM can be computed utilizing the noise injection. The weight factors represent more accurate amplitude weights (and in some conditions, the true amplitude weights). They provide a measure of point wise illumination, which may be used for illumination studies, and consequently, for acquisition design.

Noises with limited spatial extent are illustrated in FIGS. 7 and 8. It is straightforward that a noise with other characteristics can be used to derive various characters of the imaged structures or properties embedded in the acquired data. For example, if a directional noise is used, directional illumination and compensation can be done. If many and varied directional illuminations are done, many directionally illuminated images can be generated. By correlating these directionally illuminated images, amplitude versus offset/angle analysis (AVA) can be done. In seismic imaging for oil exploration, AVA is very useful for reservoir characterization.

### Limited/Finite Aperture Acquisition Compensation

In the case of a full receiver acquisition aperture, a source illumination compensated imaging condition can be determined by the zero time correlation of source and receiver wavefields divided by the zero time autocorrelation of the source wavefield, which is also referred to as source illumination:

$$I ( x ) = {\sum }_{s} \frac{〈 S , {R}_{Γ} 〉}{〈 S , S 〉} . \qquad ( 19 )$$

Here [symbol] , [symbol] denotes the inner product with respect to frequency ω, S is the source wavefield and R_{Γ} is the receiver wavefield obtained by injecting the data collected over the full receiver aperture Γ:

$${R}_{Γ} ( s , x , ω ) = {\int }_{r ∈ Γ} {G}_{0} ( r , x , ω ) {d}^{*} ( r , s , ω ) d r , \qquad ( 20 )$$

where G₀(r,x,ω) is the Green's function for a given background model, d(s, r, ω) is the recorded data at receiver r due to a source located at s, * denotes complex conjugation, and x is the image point.

In practice one often does not have the opportunity to acquire data from a full aperture but only a portion of it. Accordingly, in some embodiments, we denote the receiver aperture for each source by Γ(s) and the image formed by using the collected data by

$${I}_{P} ( x ) = {\sum }_{s} v ( s , x ) \frac{〈 S , R 〉}{〈 S , S 〉} , \qquad ( 21 )$$

where v(s, x) are referred to as migration weights and

$$R ( s , x , ω ) = {\int }_{r ∈ Γ ( s )} {G}_{0} ( r , x , ω ) {d}^{*} ( r , s , ω ) d r . \qquad ( 22 )$$

In some embodiments, we design the migration weights such that image I_{P}(x) approximates full aperture image I(x) and

$${\sum }_{s} {\vert v ( s , x ) \vert}^{2} = 1.$$

Assuming that the measurements are statistical, then the optimal weight that minimizes the expectation of

$$J ( v ) = {\sum }_{s} {{\vert}^{{v}^{- 1}} ( s , x ) \frac{〈 S , {R}_{Γ} 〉}{〈 S , S 〉} - \frac{〈 S , R 〉}{〈 S , S 〉} \vert}^{2} , \qquad ( 23 )$$

is given by

$$v ( s , x ) = \frac{E [ {\vert 〈 S , {R}_{Γ} 〉 \vert}^{2} ]}{E [ \vert 〈 S , {R}_{Γ} 〉 〈 S , R 〉 \vert ]} . \qquad ( 24 )$$

E[J(v)] provides an upper bound for the expected mean square error between I_{P}(x) and I(x) normalized with respect to Σₛ|v(s, x)|²:

$$\frac{E [ {\vert {I}_{p } ( x ) - I ( x ) \vert}^{2} ]}{{\sum }_{s} {\vert v ( s , x ) \vert}^{2}} \leq E [ J ( v ) ] . \qquad ( 25 )$$

Using the noise injection methods, considering the denominator in Eq. (24) first

$$\begin{matrix}E [ 〈 S , {R}_{Γ} 〉 〈 S , R 〉 ] = E ⌊ \begin{matrix}\int S ( s , x , ω ) {R}_{Γ}^{*} ( s , x , ω ) d ω \\ \int {S}^{*} ( s , x , {ω}^{′} ) R ( s , x , {ω}^{′} ) d {ω}^{′}\end{matrix} ⌋ \\ = E [ \begin{matrix}\int \int S ( s , x , ω ) {S}^{*} ( s , x , {ω}^{′} ) \\ {R}_{Γ}^{*} ( s , x , ω ) R ( s , x , {ω}^{′} ) d ω d {ω}^{′}\end{matrix} ] \\ = E [ \begin{matrix}\int \int S ( s , x , ω ) {S}^{*} ( s , x , {ω}^{′} ) \\ ( {\int }_{r ∈ Γ} {G}_{0}^{*} ( r , x , ω ) {\tilde{n}}^{*} ( s , r , ω ) d r ) \times \\ ( {\int }_{{r}^{′} ∈ Γ ( s )} {G}_{0} ( {r}^{′} , x , {ω}^{′} ) \tilde{n} ( s , {r}^{′} , {ω}^{′} ) d {r}^{′} ) d ω d {ω}^{′}\end{matrix} ] \\ \approx \int \int S ( s , x , ω ) {S}^{*} ( s , x , {ω}^{′} ) \times \\ ( \begin{matrix}{\int }_{{r}^{′} ∈ Γ ( s )} {\int }_{r ∈ Γ} {G}_{0} ( {r}^{′} , x , {ω}^{′} ) {G}_{0}^{*} ( r , x , ω ) \\ E [ \tilde{n} ( s , {r}^{′} , {ω}^{′} ) {\tilde{n}}^{*} ( s , r , ω ) ] d r d {r}^{′}\end{matrix} ) d ω d {ω}^{′} \\ \approx [ {t}_{max} - {t}_{min} ] [ \int {\vert S ( s , x , ω ) \vert}^{2} {\int }_{r ∈ Γ} {\vert {G}_{0} ( r , x , ω ) \vert}^{2} d r d ω ] .\end{matrix} \qquad ( 26 )$$

Use the high frequency asymptotic approximation of the Green's function:

G₀(s,x,ω)≈A(s,x)exp[iωτ(s,x)] (27)

to approximate the source wavefield as

E[ [symbol] S,R_{Γ} [symbol] [symbol] S,R [symbol] ]≈|A(s,x)|²[tₘₐₓ−tₘᵢₙ][∫∫_{rεΓ(s)}|G₀(r,x,ω)|²|p(ω)|²drdω]. (28)

Similarly for the numerator in Eq. (24),

E└ [symbol] S,R_{Γ} [symbol] |²┘≈|A(s,x)|²[tₘₐₓ−tₘᵢₙ][∫∫_{rεΓ(s)}|G₀(r,x,ω)|²|p(ω)|²drdω]. (29)

Then we have the migration weights according to some embodiments as:

$$v ( s , x ) = \frac{\int {\int }_{r ∈ Γ} {\vert {G}_{0} ( r , x , ω ) \vert}^{2} {\vert p ( ω ) \vert}^{2} d r d ω}{\int {\int }_{r ∈ Γ ( s )} {\vert {G}_{0} ( r , x , ω ) \vert}^{2} {\vert p ( ω ) \vert}^{2} d r d ω} . \qquad ( 30 )$$

Similar to Eq. (12), we have,

$$E [ {\vert {\int }_{r ∈ Γ ( s )} {G}_{0} ( r , x , ω ) p ( ω ) \tilde{n} ( s , r , ω ) d r \vert}^{2} ] = {\int }_{{r}^{′} ∈ Γ ( s )} {\int }_{r ∈ Γ ( s )} {G}_{0} ( r , x , ω ) {G}_{0}^{*} ( {r}^{′} , x , ω ) {\vert p ( ω ) \vert}^{2} E [ \tilde{n} ( s , r , ω ) {\tilde{n} }^{*} ( s , r , ω ) ] d r d {r}^{′} = [ {t}_{max} - {t}_{min} ] {\int }_{r ∈ Γ ( s )} {\vert {G}_{0} ( r , x , ω ) \vert}^{2} {\vert p ( ω ) \vert}^{2} d r \qquad ( 31 )$$

Comparing Eqs. (31) and (30), we can see that the numerator and denominator in Eq. (30) can be computed by the autocorrelation of the wavefield obtained from injecting convolution of random noise with the source wavelet. In the numerator, the noise is present on the full receiver aperture, in the denominator on the actual receiver acquisition. Note that the numerator does not vary from shot to shot, and as such can be computed just once. The weights in Eq. (30) to be applied within the imaging condition in Eq. (19) can be seen to be data independent and only depend upon the acquisition geometry, injected wavelet and the medium.

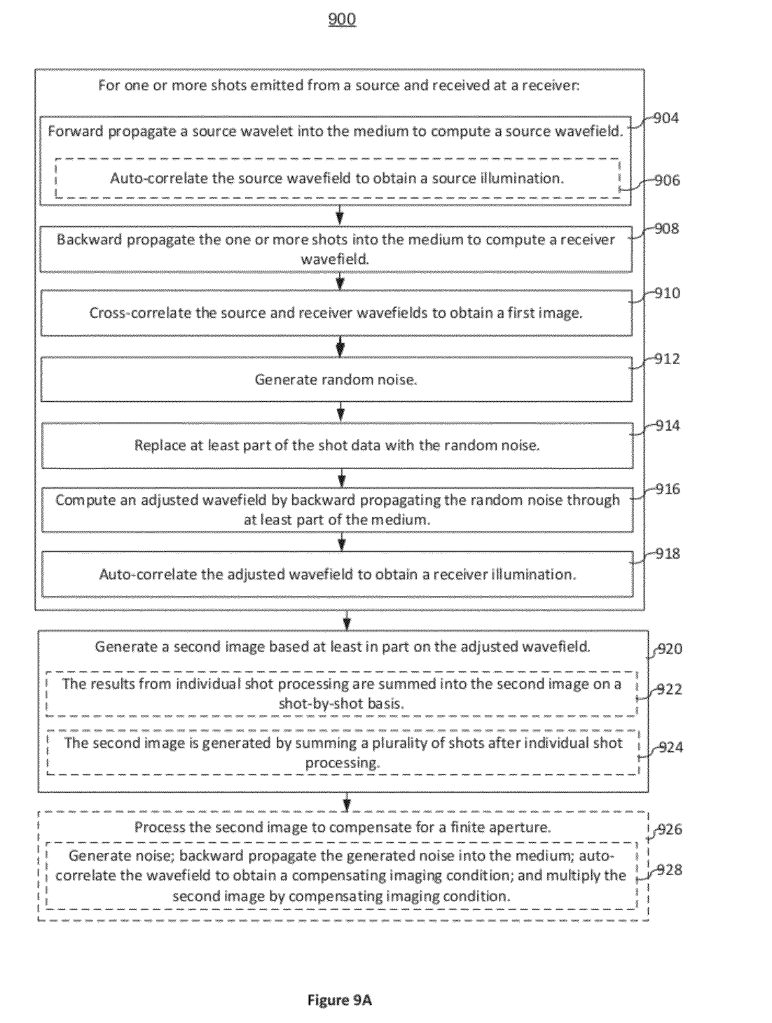

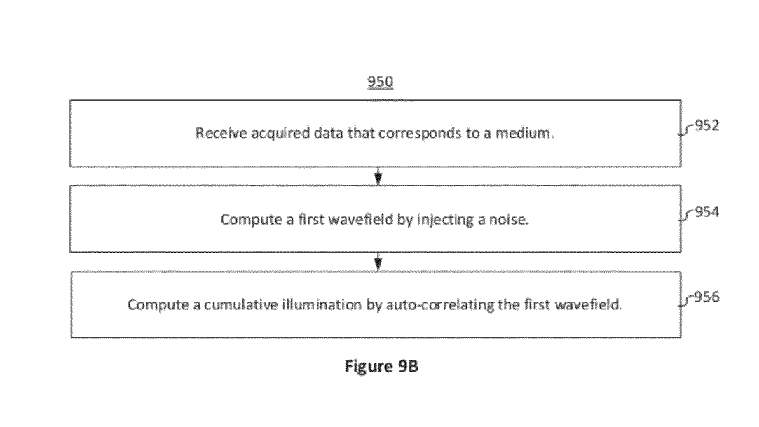

Attention is now directed to FIG. 9A, which is a flow diagram illustrating a method 900 in accordance with some embodiments. Some operations in method 900 may be combined and/or the order of some operations may be changed. Additionally, operations in method 900 may be combined with aspects of methods 100 and/or 950 discussed herein, and/or the order of some operations in method 900 may be changed to account for incorporation of aspects of methods 100 and/or 950. Method 900 may be performed by any suitable technique(s), including on an automated or semi-automated basis on computing system 1300 in FIG. 13.

In some embodiments, method 900 comprises several operations for one or more shots emitted from a source and received at a receiver (i.e., shots that were generated or emitted from the source, travel through a medium, and are received at the receiver).

A source wavelet is forward propagated into the medium to compute a source wavefield (e.g., computation of S(s,x,t), where the forward propagation relates to how a wavelet is propagated over time) (904).

In some embodiments, the source wavefield is auto-correlated to obtain a source illumination (906).

A receiver wavefield is computed by backward propagation (or backpropagation) of the one or more shots into the medium (e.g., R(s,x,t)) (908).

The source and receiver wavefields are cross-correlated to obtain a first image (e.g., [symbol] S, R [symbol] ) (910).

Random noise is generated (912). Those with skill in the art will recognize that many types of noise may be successfully employed, including, but not limited to Gaussian white noise (zero mean and unit variance).

At least part of the shot data is replaced with the random noise (914). In some embodiments, the shot data is replaced with the random noise.

An adjusted wavefield (e.g., Rn(s,x,t)) is computed by backward propagating the random noise through at least part of the medium (916).

The adjusted wavefield is auto-correlated to obtain a receiver illumination (918). In some embodiments, the auto-correlation is based at least in part on the use of the random noise.

A second image is generated based at least in part on the adjusted wavefield (920). In some embodiments, the results from individual shot processing are summed into the second image on a shot-by-shot basis (i.e., calculate [symbol] S,R [symbol] / [symbol] S,S [symbol] [symbol] Rn,Rn [symbol] ) and sum the results from individual shots into an image) (922). In some embodiments, the second image is generated by summing a plurality of shots after individual shot processing (i.e., calculate

$${\sum }_{shots} 〈 S , R 〉 / {\sum }_{shots} ( 〈 S , S 〉 〈 Rn , Rn 〉 ) ) ( 924 ) .$$

In some embodiments, the second image is processed to compensate for a finite aperture (926). In some embodiments, the image processing for the second image includes generating noise (e.g., including, but not limited to the example of Gaussian white noise); backward propagation of the generated noise into the medium; auto-correlation of the adjusted wavefield to obtain a compensating imaging condition (e.g., [symbol] Rn_{Γ}, Rn_{Γ} [symbol] ); and processing the second image with the compensating imaging condition (e.g., including, but not limited to the example of multiplying the second image by [symbol] Rn_{Γ}, Rn_{Γ} [symbol] ) (928).

It is noted that, when imaging condition Eq. (19) is replaced with any weighted imaging condition with weights depending only on the source location and imaging coordinate, v(s,x), presented in Eq. (24) or (30), can be used without modification. For example, in the case of true amplitude imaging, the weights of the imaging condition include the cosine square or cube of the incident angle at the imaging coordinate (see Eq. (10) Kiyashchenko et al. and equations (27) and (27a) in Miller et al. 1987). In practice for RTM, this cosine related term is implemented by a Laplacian flow that is based on Eq. (6) of Zhang and Sun (2008).

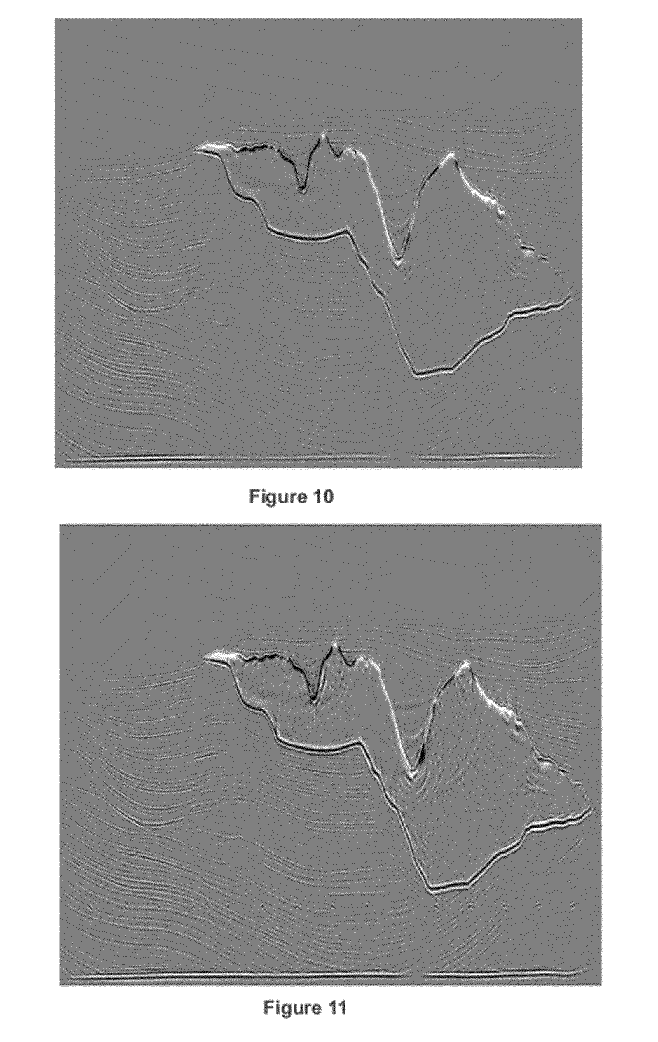

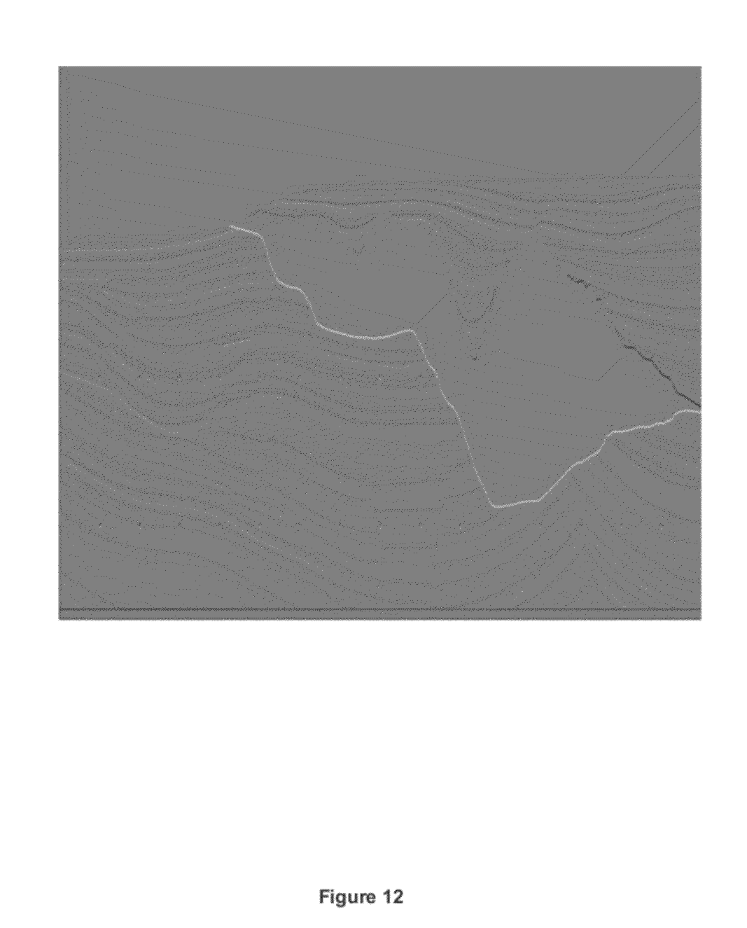

The weights for limited receiver aperture compensation computed by Eq. (30) have been tested on the Sigsbee model. We use 12 seconds (maximum time in the data) of Gaussian white noise when computing the finite/limited receiver aperture weights, adding an overhead of an extra 50% to the migration. We show conventional RTM images of I(x) and I_{P}(x), obtained by combination of Eqs. (19) and (21), with the aforementioned Laplacian flow in FIGS. 10 and 11, respectively. The improvement from applying the limited aperture receiver weights can clearly be seen. For comparison, the normal incidence reflectivity of the Sigsbee model is provided in FIG. 12.

In some embodiments, method 900 is used for computation of imaging condition Eq. (19) using the weights in Eq. (30), which is similar to Eq. (12), for the source wavelet.

In some embodiments, method 900 may utilize an improved amplitude form of migration weights that relate to fixed spread geometries Γ(xₛ)=Γ∀xₛ. In some embodiments, these improved migration weightst', can be calculated, estimated, and/or derived from equation 31a, which can be expressed as

$$w ( x ) = \frac{( {\sum }_{ω} {\sum }_{{x}_{r} ∈ Γ} {\vert G ( x , {x}_{r} , ω ) \vert}^{2} )}{( {\sum }_{ω} {ω}^{4} {\vert f ( {x}_{s} , x , ω ) \vert}^{2} {\vert G ( {x}_{s} , x , ω ) \vert}^{2} ) ( {\sum }_{ω} {\sum }_{{x}_{r} ∈ Γ ( {x}_{s} )} {\vert G ( x , {x}_{r} , ω ) \vert}^{2} )} , \qquad ( 31 a )$$

for a shot-by-shot image or by summing a plurality of shots

$$w ( x ) = \frac{( {\sum }_{ω} {\sum }_{{x}_{r} ∈ Γ} {\vert G ( x , {x}_{r} , ω ) \vert}^{2} )}{{\sum }_{{x}_{s}} [ \begin{matrix}( {\sum }_{ω} {ω}^{4} {\vert f ( {x}_{s} , x , ω ) \vert}^{2} {\vert G ( {x}_{s} , x , ω ) \vert}^{2} ) \\ ( {\sum }_{ω} {\sum }_{{x}_{r} ∈ Γ ( {x}_{s} )} {\vert G ( x , {x}_{r} , ω ) \vert}^{2} )\end{matrix} ]} , \qquad ( 31 b )$$

to obtain a globally weighted image.

As noted above, in some embodiments, migration weights (such as those of equation (31a)) can be employed on a shot-by-shot basis. In alternate embodiments, migration weights can be employed as part of a global normalization scheme (such as those of equation 31b). In further embodiments, migration weights can be employed as part of a hybrid normalization scheme employing a combination of shot-by-shot and global normalization schemes.

In some embodiments, one or more weights may be obtained by computing coherence of a synthetic trace with a trace in acquired data. For example, the first wavefield is recorded at a source location and at a receiver location, wherein the first wavefield is based at least in part on the injected noise; a synthetic trace is generated by convolving the recorded wavefield at the source location with the recorded wavefield at the receiver location; and one or more weights are obtained by computing coherence of the synthetic trace with a trace in the acquired data, wherein the synthetic trace corresponds to the trace in the acquired data, e.g., both the synthetic trace and the trace in the acquired data share a source location and a receiver location.

Attention is now directed to FIG. 9B, which is a flow diagram illustrating a method 950 in accordance with some embodiments. Some operations in method 950 may be combined and/or the order of some operations may be changed. Additionally, operations in method 950 may be combined with aspects of methods 100 and/or 900 discussed herein, and/or the order of some operations in method 950 may be changed to account for incorporation of aspects of methods 100 and/or 950. Method 950 may be performed by any suitable technique(s), including on an automated or semi-automated basis on computing system 1300 in FIG. 13.

In some embodiments, method 950 comprises operations for one or more shots emitted from a source and received at a receiver (i.e., shots that were generated or emitted from the source, travel through a medium, and are received at the receiver).

Method 950 includes receiving (952) data acquired that corresponds to a medium, such as one or more shots emitted from a seismic source and received at a receiver.

A first wavefield is computed (954) by injecting a noise, which may be any of the noise types discussed herein, or any other suitable noise type as those with skill in the art would find appropriate for the acquired dataset being processed.

A cumulative illumination is computed (956) by auto-correlating the first wavefield.

While many equations, inequalities and mathematical expressions (collectively, the mathematical expressions) have been provided and/or derived in the foregoing disclosure, those with skill in the art will appreciate that the various embodiments disclosed herein may be practiced successfully with variations of the foregoing mathematical expressions, as well all alternative and suitable methods of obtaining, calculating, estimating, and/or deriving the varying data needed to practice the various embodiments.

### Computing Systems

FIG. 13 depicts an example computing system 1300 in accordance with some embodiments. The computing system 1300 can be an individual computer system 1301A or an arrangement of distributed computer systems. The computer system 1301A includes one or more analysis modules 1302 that are configured to perform various tasks according to some embodiments, such as the tasks depicted in FIGS. 1 and 9. To perform these various tasks, analysis module 1302 executes independently, or in coordination with, one or more processors 1304, which is (or are) connected to one or more storage media 1306. The processor(s) 1304 is (or are) also connected to a network interface 1308 to allow the computer system 1301A to communicate over a data network 1310 with one or more additional computer systems and/or computing systems, such as 1301B, 1301C, and/or 1301D (note that computer systems 1301B, 1301C and/or 1301D may or may not share the same architecture as computer system 1301A, and may be located in different physical locations, e.g., computer systems 1301A and 1301B may be on a ship underway on the ocean, while in communication with one or more computer systems such as 1301C and/or 1301D that are located in one or more data centers on shore, other ships, and/or located in varying countries on different continents).

A processor can include a microprocessor, microcontroller, processor module or subsystem, programmable integrated circuit, programmable gate array or another control or computing device.

The storage media 1306 can be implemented as one or more computer-readable or machine-readable storage media. Note that while in the exemplary embodiment of FIG. 13 storage media 1306 is depicted as within computer system 1301A, in some embodiments, storage media 1306 may be distributed within and/or across multiple internal and/or external enclosures of computing system 1301A and/or additional computing systems. Storage media 1306 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 1300 is only one example of a computing system, and that computing system 1300 may have more or fewer components than shown, may combine additional components not depicted in the exemplary embodiment of FIG. 13, and/or computing system 1300 may have a different configuration or arrangement of the components depicted in FIG. 13. The various components shown in FIG. 13 may be implemented in hardware, software or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs or other appropriate devices. These modules, combinations of these modules and/or their combination with general hardware are all included within the scope of protection of the invention.

While certain implementations have been disclosed in the context of seismic data collection and processing, those with skill in the art will recognize that the disclosed methods can be applied in many fields and contexts where data involving structures arrayed in a three-dimensional space may be collected and processed, e.g., medical imaging techniques such as tomography, ultrasound, MRI and the like, SONAR and LIDAR imaging techniques and the like.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Various references that provide further information have been referred to above, and each is incorporated by reference.
Chattopadhyay, S. and G. A. McMechan, 2008, “Imaging conditions for prestack reverse-time-migration,” Geophysics, 73, no. 3, S81-S89.
Costa, J. C., F. A. Silva Neto, M. R. M. Alcantara, J. Schleicher and A. Novais, 2009, “Obliquity-correction imaging condition for reverse time migration,” Geophysics, 74, no. 3, S57-S66.
Haney, M. M., L. C. Bartel, D. F. Aldridge and N. P. Symons, 2005, “Insight into the output of reverse-time migration: What do amplitudes mean?,” 75th International Annual Meeting, SEG, Expanded Abstracts, 1950-1953.
Zhang, Y and J. Sun, 2008, “Practical issues of reverse time migration: true-amplitude gathers, noise removal and harmonic-source encoding,” 70th EAGE Conference & Exhibition., 3784.
A. A. Valenciano, B. L. Biondi and R. G. Clapp, 2009, “Imaging by target-oriented wave-equation inversion,” Geophysics, 74, WCA109-WCA120.
D. Kiyashchenko, R.-E. Plessix, B. Kashtan and V. Troyan, 2007, “A modified imaging principle for true-amplitude wave-equation migration,” Geophys. J. Int. 168, 1093-1104.
D. Miller, M. Oristaglio and G. Beylkin, 1987, “A new slant on seismic imaging: Migration and integral geometry,” Geophysics 52, 943-964.
Plessix, R. E. and Mulder, W. A., 2004, “Frequency-domain finite-difference amplitude-preserving migration,” Geophys. J. Int. (2004) 157, 975-987.

We claim:

1. A method for obtaining a cumulative illumination of a medium for imaging or modeling, the method comprising:
receiving acquired data that corresponds to the medium;
computing a first wavefield by injecting a noise; and
computing the cumulative illumination by auto-correlating the first wavefield.

2. The method of claim 1, wherein the noise is injected at one or more receiver locations.

3. The method of claim 1, wherein the noise is injected into a region of interest in the medium.

4. The method of claim 1, further comprising:
computing a source wavefield by injecting a source waveform into the medium; and
computing a source illumination by autocorrelation of the source wavefield.

5. The method of claim 4, further comprising:
cross-correlating the source wavefield and the first wavefield to obtain a first image; and
computing an illumination balanced image by dividing the image with the source illumination and the cumulative illumination.

6. The method of claim 1, wherein the noise is white noise having zero mean and unit variance.

7. The method of claim 1, wherein the noise is based at least in part on an image statistic selected from the group consisting of ergodicity, level of correlation, and stationarity.

8. The method of claim 5, wherein the noise is a directional noise along a direction of interest, and wherein the illumination balanced image is illuminated along the direction of interest.

9. The method of claim 8, further comprising:
varying the direction of the directional noise to generate a directionally illuminated image; and
correlating the directionally illuminated image for amplitude variation along angles analysis.

10. The method of claim 1, further comprising:
recording the first wavefield at a source location and at a receiver location, wherein the first wavefield is based at least in part on the injected noise;
generating a synthetic trace by convolving the recorded wavefield at the source location with the recorded wavefield at the receiver location; and
obtaining one or more weights by computing coherence of the synthetic trace with a trace in the acquired data.

11. The method of claim 5, wherein the first image is for seismic imaging, and the weights are calculated for Reverse Time Migration (RTM) or Full Waveform Inversion (FWI).

12. The method of claim 5, further comprising:
computing a receiver wavefield by backward propagation of one or more shots into the medium;
generating a random noise;
replacing at least part of the acquired data with the random noise;
computing an adjusted wavefield by backward propagating the random noise through at least part of the medium; and
computing a receiver illumination by auto-correlating the adjusted wavefield.

13. The method of claim 12, further comprising generating a second image based at least in part on the adjusted wavefield.

14. The method of claim 13, wherein the second image is generated by summing a plurality of processed shots into the second image on a shot-by-shot basis.

15. The method of claim 13, wherein the second image is generated by summing a plurality of shots after individual shot processing.

16. The method of claim 12, further comprising processing the second image to compensate for a finite aperture.

17. The method of claim 16, wherein the image processing for the second image includes:
generating a third noise;
backward propagation of the generated third noise into the medium;
auto-correlation of the adjusted wavefield to obtain a compensating imaging condition; and
processing the second image with the compensating imaging condition.

18. The method of claim 5, wherein the image is for seismic imaging, radar imaging, sonar imaging, thermo-acoustic imaging or ultra-sound imaging.

19. A computing system, comprising:
at least one processor;
at least one memory; and
one or more programs stored in the at least one memory, wherein the one or more programs are configured to be executed by the one or more processors, the one or more programs including instructions for:
receiving acquired data that corresponds to the medium;
computing a first wavefield by injecting a noise; and
computing the cumulative illumination by auto-correlating the first wavefield.

20. The computing system of claim 19, further comprising cross-correlating the source wavefield and the first wavefield to obtain a first image.

21. The computing system of claim 19, wherein the first image is for seismic imaging, radar imaging, sonar imaging, thermo-acoustic imaging or ultra-sound imaging.
